(19) United States
(12) Patent Application Publication
(10) Pub. No.: US 2011/0159382 A1
(43) Pub. Date: Jun. 30, 2011

(54) NONAQUEOUS SOLVENT, AND NONAQUEOUS ELECTROLYTE SOLUTION AND NONAQUEOUS SECONDARY BATTERY USING THE SAME

(76) Inventors: Toru Matsui, Osaka (JP); Masato Fujikawa, Osaka (JP)

(21) Appl. No.: 13/003,182

(22) PCT Filed: Apr. 27, 2010
(86) PCT No.: PCT/JP2010/003004

§ 371 Date: Jan. 7, 2011

(30) Foreign Application Priority Data
May 8, 2009 (JP) 2009-113344

(51) Int. Cl. H01M 6/16; B01F 1/00

(52) U.S. Cl. 429/338; 252/364

(57) ABSTRACT

The nonaqueous solvent of the present invention for a nonaqueous secondary battery primarily contains a mixed solvent of a fluorinated cyclic carbonate having a structure in which one fluorine atom is bonded to each of two alkoxy group carbon atoms adjacent to carbonate oxygen atoms and a fluorinated acyclic carbonate having a similar structure. The fluorinated cyclic carbonate, in comparison with the unsubstituted cyclic carbonate, has not only an enhanced thermal stability but also a suppressed reactivity with the positive electrode in a charged state even at elevated temperatures. In addition, it forms a protective film which, with respect to a negative electrode in a charged state, suppresses reactivity between the negative electrode and the nonaqueous electrolyte solution. The fluorinated acyclic carbonate suppresses the reactivity with the positive electrode in a charged state and also lowers the viscosity of the nonaqueous electrolyte solution.

### TECHNICAL FIELD

The present invention relates to nonaqueous solvents for use in nonaqueous electrolyte solutions for nonaqueous secondary batteries. In particular, the invention relates to improvements in nonaqueous solvents for use in such nonaqueous electrolyte solutions.

### BACKGROUND ART

Development has been carried out to date on nonaqueous secondary batteries which use a transition metal oxide as the positive electrode active material and use a layered carbon compound as the negative electrode active material, and specifically lithium ion batteries. Here, lithium cobaltate (LiCoO₂), lithium nickelate (LiNiO₂), lithium manganate (LiMn₂O₄), lithium iron phosphate (LiFePO₄) and the like are used as the transition metal oxide. Artificial graphite, natural graphite and the like are used as the layered carbon compound. Also, electrolyte solutions, gel electrolytes and polymer electrolytes in which an alkali metal salt such as a lithium salt has been dissolved are used as the electrolyte responsible for ion conduction between the positive electrode and the negative electrode. These are all nonaqueous systems.

The increase in performance and functionality of notebook computers, cell phones, handheld gaming consoles and the like has brought with it a strong desire for higher energy density in nonaqueous secondary batteries. At the same time, improvements in battery safety and reliability are being sought to enable the worry-free use of high energy density nonaqueous secondary batteries.

In a nonaqueous secondary battery in a charged state, the positive electrode active material has reactivity as an oxidizing agent and the negative electrode active material has reactivity as a reducing agent. Raising the energy density of a nonaqueous secondary battery increases the electrochemical energy that can be effectively extracted from the battery. For this reason, the difference between the chemical energy held by the positive electrode as the oxidizing agent and the chemical energy held by the negative electrode as the reducing agent must be increased.

At the same time, to enhance the safety of a nonaqueous secondary battery, it is necessary to avoid, in circumstances such as those listed below, release of the chemical energy difference between the oxidizing agent and the reducing agent in a short period of time due to the occurrence of chain-like chemical reactions therebetween:
(1) direct contact between the positive electrode and the negative electrode, or contact through an electrically conductive substance;
(2) heat generation in local areas of contact;
(3) spontaneous decomposition of the positive electrode or negative electrode active material that has reached a locally elevated temperature, and the spreading of heat generation;
(4) further heat generation due to reactions between the products of spontaneous decomposition at the positive electrode or negative electrode and the opposing electrode active material;
(5) oxidation or reduction of other materials within the battery due to the reaction-activated positive electrode or negative electrode; and
(6) simultaneous progression of the reactions in (1) to (5) due to spreading of the generated heat throughout the battery.

To suppress such heat generating reactions within a nonaqueous secondary battery, it is desired not only that contact between the positive electrode and the negative electrode be avoided, but also that the thermal stability (also referred to below as the “thermodynamic stability”) of materials used within the battery—including the positive electrode and negative electrode active materials—be improved. In addition, it is demanded that, in the unlikely event that a thermally unstable state should arise, reactions such as spontaneous decomposition shall be made to proceed very slowly (also referred to below as “kinetic stability”).

Nonaqueous electrolyte solutions for nonaqueous secondary batteries are prepared by dissolving an alkali metal salt such as lithium hexafluorophosphate (LiPF₆) in a nonaqueous solvent such as ethylene carbonate (EC) or diethyl carbonate (DEC). Ethylene carbonate is a cyclic compound, and diethyl carbonate is an acyclic compound.

Regarding the thermal stability of the nonaqueous electrolyte solution itself, in a nonaqueous electrolyte solution wherein a mixed solvent of EC and DEC is used as the nonaqueous solvent and LiPF₆ is used as the alkali metal salt, heat generation is known to begin from about 180° C. (Non-Patent Document 1). Yet, when a layered carbon compound (Li_{0.81}C) in a charged state is also present, heat generation can already be observed when the temperature has exceeded 90° C. (Non-Patent Document 2). When lithium cobaltate (Li_{0.5}CoO₂) in a charged state is also present, heat generation begins from about 130° C. (Non-Patent Document 3). In order to enhance the safety of nonaqueous secondary batteries, it is necessary to take into consideration not only the thermal stability of the materials used in the battery, but also the reactivity when different materials have been combined (also referred to below as the “chemical reaction stability”).

Nonaqueous electrolyte solutions which enhance the thermal stability of nonaqueous secondary batteries, including the storage properties of the nonaqueous electrolyte solution at about 60° C., have been proposed. For example, there are nonaqueous electrolyte solutions obtained by using a nonaqueous solvent wherein some or all of the hydrogens present in a five-membered ring cyclic carbonate are substituted with halogens or, similarly, a nonaqueous solvent in which the hydrogens on an acyclic carbonate are substituted with halogens, to dissolve lithium bis(perfluoroalkylsulfonyl)imide (Patent Document 1). By using such a nonaqueous electrolyte solution, it is purported that the self-discharge characteristics of the battery at elevated temperatures that arise with the use of the imide salt can be improved.

Nonaqueous electrolyte solutions which use a mixed nonaqueous solvent composed of a nonaqueous solvent that is a five-membered ring cyclic carbonate partially substituted with halogens and an unsubstituted acyclic carbonate have been proposed (Patent Document 2). Using this nonaqueous electrolyte solution reportedly enables a secondary battery to achieve both safety and performance.

In addition, a nonaqueous electrolyte solution which uses a nonaqueous solvent obtained by substituting some of the hydrogens on dimethyl carbonate (DMC), an acyclic carbonate, with halogens has been proposed (Patent Document 3). Using this nonaqueous electrolyte solution reportedly enables a secondary battery of excellent cycle performance and low-temperature properties to be obtained.
Patent Document 1: Japanese Patent Application Laid-open No. H10-247519
Patent Document 2: Japanese Patent Application Laid-open No. H10-189043
Patent Document 3: Japanese Patent Application Laid-open No. H10-144346
Non-Patent Document 1: Journal of Loss Prevention in the Process Industries, 19 (2006), 561-569
Non-Patent Document 2: Electrochimica Acta, 49 (2004), 4599-4604
Non-Patent Document 3: Thermochimica Acta, 437 (2005), 12-16

### SUMMARY OF THE INVENTION

With regard to the thermodynamic stability of nonaqueous solvents, it can easily be inferred that substituting some of the hydrogens on a nonaqueous solvent with halogens, particularly fluorine, will enhance the thermodynamic stability of the nonaqueous solvent. However, it is difficult to predict the kinetic stability when a fluorinated nonaqueous solvent carries out dissolution and the chemical reaction stability when a positive electrode and a negative electrode come into contact; and thus, the synthesis and combination of materials for investigating these questions are nearly infinite. From investigations by the inventors, it has been confirmed that even when the nonaqueous electrolyte solutions described in the above-mentioned prior arts are incorporated into a nonaqueous secondary battery, it is not possible to achieve both battery safety and also general properties such as high-temperature storage properties and discharge load properties.

The present invention was arrived at in light of the above problems. One object of the invention is to improve the thermal stability of a nonaqueous electrolyte solution which includes a nonaqueous solvent that contains fluorine on the molecule, and to thereby improve the safety of the nonaqueous secondary battery in which such a nonaqueous electrolyte solution is used. Another object of the invention is to achieve both an excellent safety and excellent general properties in nonaqueous secondary batteries by specifying, of the nearly infinite fluorine-containing nonaqueous solvents, those with molecular structures suitable for the former object and by devising combinations of such nonaqueous solvents.

An aspect of the present invention is directed to a nonaqueous solvent for a nonaqueous secondary battery, wherein the solvent contains (A) at least one fluorinated cyclic carbonate selected from the group consisting of a fluorinated cyclic carbonate represented by the following formula (I)

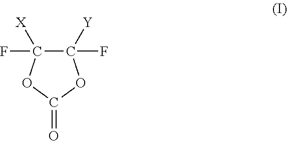

(where, F is fluorine, and X and Y are independently hydrogen or an alkyl group with 1 to 4 carbons) and a fluorinated cyclic carbonate represented by the following formula (II)

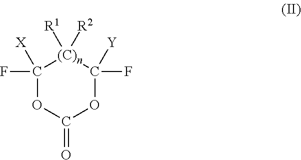

(where, F is fluorine, X and Y are independently hydrogen or an alkyl group with 1 to 4 carbons, R¹ and R² are independently hydrogen or an alkyl group with 1 to 4 carbons, and n is an integer from 1 to 3), and
(B) a fluorinated acyclic carbonate represented by the following formula (III)

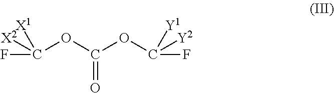

(where, F is fluorine, and X¹, X², Y¹ and Y² are independently hydrogen or an alkyl group with 1 to 4 carbons).

That is, the nonaqueous solvent of the invention is characterized by including as the main component a mixed solvent of (A) a fluorinated cyclic carbonate having one fluorine atom at each of two specific positions on the molecule and (B) a fluorinated acyclic carbonate similarly having one fluorine atom at each of two specific positions on the molecule.

The objects, features, aspects and advantages of the invention will become more apparent from the following detailed description and the accompanying diagram.

### BRIEF DESCRIPTION OF THE DRAWINGS

FIG. 1 is a longitudinal sectional view schematically showing the structure of a cylindrical nonaqueous secondary battery according to one embodiment of the invention.

### MODE FOR CARRYING OUT THE INVENTION

According to the investigations by the inventors, as described above, it was confirmed that when nonaqueous electrolyte solutions disclosed in the prior arts are incorporated into a nonaqueous secondary battery, it was not possible to achieve both battery safety and also general properties such as high temperature storage properties and discharge load properties.

For example, when a battery was made by using a nonaqueous electrolyte solution (corresponding to BA25 in Table 6 of above-mentioned Patent Document 1) obtained by dissolving lithium bis(pentafluoroethylsulfonyl)imide (LiBETI) in a mixed nonaqueous solvent of 4-fluoro-1,3-dioxolan-2-one (fluoroethylene carbonate) as the cyclic carbonate with monofluoromethyl methyl carbonate as the acyclic carbonate, gas evolution has been high during high-temperature storage of the battery, in addition to which battery safety has been inadequate.

When a battery was made by applying a nonaqueous electrolyte solution (which was prepared while referring to above Patent Document 2) obtained using 4,5-difluoro-1,3-dioxolan-2-one (difluoroethylene carbonate) as the cyclic carbonate and using DMC as the acyclic carbonate, it became apparent that the reactivity with the positive electrode in a charged state was pronounced.

In addition, when a battery was made by using a nonaqueous electrolyte solution (which was prepared while referring to solvent No. 7 in Table 1 of the above Patent Document 3) obtained by dissolving LiPF₆ in bis(monofluoromethyl) carbonate, the discharge load properties of the battery fell short of what was acceptable.

The present invention was arrived at based on the results of investigations such as those above. Embodiments for carrying out the invention are described in detail below.

Nonaqueous Solvent

The nonaqueous solvent according to an embodiment of the invention includes (A) at least one fluorinated cyclic carbonate selected from the group consisting of a fluorinated cyclic carbonate represented by the following formula (I)

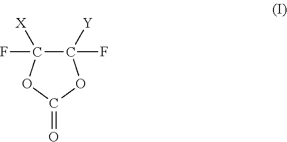

(where, F is fluorine, and X and Y are independently hydrogen or an alkyl group with 1 to 4 carbons) and a fluorinated cyclic carbonate represented by the following formula (II)

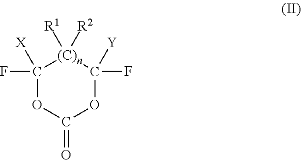

(where, F is fluorine, X and Y are independently hydrogen or an alkyl group with 1 to 4 carbons, R¹ and R² are independently hydrogen or an alkyl group with 1 to 4 carbons, and n is an integer from 1 to 3), and (B) a fluorinated acyclic carbonate represented by the following formula (III)

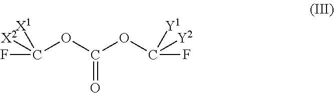

(where, F is fluorine, and X¹, X², Y¹ and Y² are independently hydrogen or an alkyl group with 1 to 4 carbons).

The fluorinated cyclic carbonate (A) according to the embodiment of the invention is at least one kind selected from the group consisting of a fluorinated cyclic carbonate represented by formula (I) and a fluorinated cyclic carbonate represented by formula (II).

The fluorinated cyclic carbonate represented by formula (I) is a five-membered ring cyclic carbonate which has a structure wherein one fluorine atom is bonded to each of two alkoxy group carbon atoms adjacent to carbonate oxygen atoms. The X and Y moieties bonded to the same carbons are independently hydrogen or an alkyl group with 1 to 4 carbons. Preferably, X and Y are independently hydrogen, methyl or ethyl group. Even if this compound is a solid at a room temperature due to the combination of X and Y, this does not pose any problem so long as a nonaqueous electrolyte solution prepared by using this compound becomes a liquid.

In the fluorinated cyclic carbonate represented by formula (I), the combinations of X and Y shown in Table 1 below are preferred.

TABLE I

| Nonaqueous | | |
|---|---|---|
| solvent | X | Y |
| A | H | H |
| B | H | CH₃ |
| C | CH₃ | CH₃ |
| D | H | C₂H₅ |
| E | CH₃ | C₂H₅ |
| F | C₂H₅ | C₂H₅ |

Among these, the fluorinated cyclic carbonates having the combinations shown in nonaqueous solvent A, nonaqueous solvent B and nonaqueous solvent C are preferred. The fluorinated cyclic carbonate having the combination shown in nonaqueous solvent A is especially preferred. This is difluoroethylene carbonate, which has the following formula (IV).

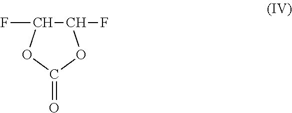

The fluorinated cyclic carbonate represented by formula (II) is a six-membered ring (n=1) to eight-membered ring (n=3) cyclic carbonate which similarly has a structure wherein one fluorine is bonded to each of two alkoxy group carbon atoms adjacent to the carbonate oxygen atoms. X and Y are independently hydrogen or alkyl groups with 1 to 4 carbons, and preferably hydrogen, methyl or ethyl. R¹ and R² are independently hydrogen or alkyl groups with 1 to 4 carbons, and preferably hydrogen or methyl. The letter n is an integer from 1 to 3, and is preferably 1. In particular, the alkylene group represented as (CR¹R²)ₙ in formula (II) is preferably a methylene group (CH₂).

In the fluorinated cyclic carbonate represented by formula (II), preferred combinations of X, Y and the alkylene group represented as (CR¹R²)ₙ are the combinations shown in Table 2 below.

TABLE 2

| Nonaqueous | | | |
|---|---|---|---|
| solvent | X | Y | Alkylene group |
| G | H | H | CH₂ |
| H | H | CH₃ | CH₂ |
| I | CH³ | CH₃ | CH₂ |

The fluorinated cyclic carbonate (A) is preferably either a fluorinated five-membered ring cyclic carbonate represented by formula (I) or a fluorinated six-membered ring (n=1) cyclic carbonate represented by formula (II), and is more preferably composed of a fluorinated five-membered ring cyclic carbonate represented by formula (I) alone.

The nonaqueous solvent according to an embodiment of the invention is a mixture of (A) the above fluorinated cyclic carbonate and (B) a fluorinated acyclic carbonate represented by the following formula (III).

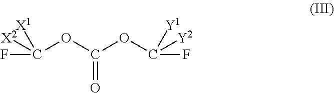

(where, F is fluorine, and X¹, X², Y¹ and Y² are independently hydrogen or an alkyl group with 1 to 4 carbons).

The fluorinated acyclic carbonate (B) represented by formula (III) has, similar to the above fluorinated cyclic carbonate (A), a structure wherein one fluorine atom is bonded to each of two alkoxy group carbon atoms adjacent to the carbonate oxygen atom. The X¹, X², Y¹ and Y² moieties bonded to said carbon atoms are independently hydrogen or an alkyl group with 1 to 4 carbons, and are preferably hydrogen, methyl or ethyl. Even if this compound is a solid at a room temperature due to the combination of X¹, X², Y¹ and Y², this does not pose any problem so long as a nonaqueous electrolyte solution prepared by using the compound becomes a liquid.

In the fluorinated acyclic carbonate (B) represented by formula (III), the combination X¹, X², Y¹ and Y² is preferably a combination shown in Table 3 below.

TABLE 3

| Nonaqueous | | | | |
|---|---|---|---|---|
| solvent | X¹ | X² | Y¹ | Y² |
| a | H | H | H | H |
| b | H | H | H | CH₃ |
| c | H | CH₃ | H | CH₃ |
| d | H | H | H | C₂H₅ |
| e | H | CH³ | H | C₂H₅ |
| f | H | C₂H₅ | H | C₂H₅ |

Among these, the fluorinated acyclic carbonates having the combinations shown in nonaqueous solvent a, nonaqueous solvent b and nonaqueous solvent c are preferred. The fluorinated acyclic carbonates having the combinations shown in nonaqueous solvent a, nonaqueous solvent b and nonaqueous solvent c are represented by the following formulas (V), (VI) and (VII), respectively.

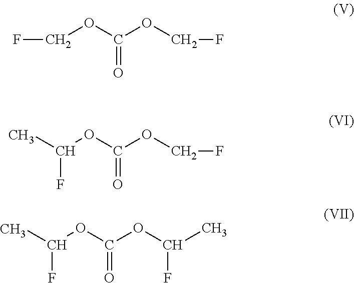

The fluorinated acyclic carbonate represented by formula (V), the fluorinated acyclic carbonate represented by formula (VI) and the fluorinated acyclic carbonate represented by formula (VII) may each be used independently as the fluorinated acyclic carbon (B), or any two or more of these may be used in admixture.

The fluorinated acyclic carbonate (B) represented by formula (III) is able to assume a conformation wherein, due to free rotation of the C—O bond between the carbonate oxygen atom as the center of rotation and the alkoxy group carbon atom adjacent thereto, the two alkoxy group carbon atoms are mutually in close proximity as shown in formula (VIII) below. In particular, when lithium ions are solvated in the electrolyte solution by the fluorinated acyclic carbonate represented by formula (III), the fluorinated acyclic carbonate readily assumes the conformation represented by formula (VIII) so as to avoid steric repulsion with other solvated molecules.

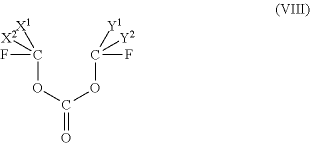

The fluorinated acyclic carbonate (B) in the present embodiment, because of its ability to undergo the conformational change wherein the two alkoxy group carbon atoms are mutually in close proximity, is capable of becoming a steric structure having a configuration similar to the fluorinated cyclic carbonate represented by formula (I) or the fluorinated cyclic carbonate represented by formula (II) which is present together within the nonaqueous solvent. By thus causing the fluorinated acyclic carbonate (B) to become the steric structure similar to that of the fluorinated cyclic carbonate (A), both compounds interact more easily. It is presumed that such interactions produce the synergistic actions and effects of the present invention.

The mixing proportions of the fluorinated cyclic carbonate (A) with the fluorinated acyclic carbonate (B) are preferably set so that the molar ratio, expressed as (A)/(B), is preferably from 1/9 to 9/1. As noted above, because both compounds, by having the ability to result in the similar steric structures, interact and give rise to the synergistic effects, the mixing proportions of both, expressed as the molar ratio (A)/(B), is more preferably from 3/7 to 7/3.

The nonaqueous solvent according to an embodiment of the invention may also include, in addition to the fluorinated cyclic carbonate (A) and the fluorinated acyclic carbonate (B), a plurality of other nonaqueous solvents. The mixing proportions with the other nonaqueous solvents are set so that the molar ratio with respect to the fluorinated cyclic carbonate (A) and the fluorinated acyclic carbonate (B) combined, expressed as [(A)+(B)]/(other solvents combined), is in a range of preferably from 10/0 to 7/3. This means that the fluorinated cyclic carbonate (A) and the fluorinated acyclic carbonate (B) have a combined content (A)+(B) in the nonaqueous solvent of preferably from 70 to 100 mol %. When the content of unfluorinated nonaqueous solvents increases, the reactivity with the positive electrode in a charged state tends to rise.

Examples of other nonaqueous solvents that may be used together with the fluorinated cyclic carbonate (A) and the fluorinated acyclic carbonate (B) include cyclic carbonates such as ethylene carbonate (EC), propylene carbonate (PC) and butylene carbonate (BC); cyclic esters such as γ-butyrolactone, α-methyl-γ-butyrolactone and γ-valerolactone; and acyclic carbonates such as dimethyl carbonate (DMC), ethyl methyl carbonate (EMC), diethyl carbonate (DEC), methyl propyl carbonate (MPuC), methyl butyl carbonate (MBC) and methyl pentyl carbonate (MPeC). Mixing a cyclic carbonate with a cyclic ester promotes dissociation of the alkali metal salt. Also, mixing in particular an acyclic carbonate having an alkyl group with at least the length of ethyl group improves the affinity between the nonaqueous electrolyte solution and a polyolefin separator.

Other nonaqueous solvents that may be included are cyclic carbonates having C═C unsaturated bonds. Examples include vinylene carbonate, vinyl ethylene carbonate, divinyl ethylene carbonate, phenyl ethylene carbonate and diphenyl ethylene carbonate.

Other nonaqueous solvents that may be included are cyclic esters having a C═C unsaturated bond. Examples include furanone, 3-methyl-2(5H)-furanone and α-angelica lactone.

Still other nonaqueous solvents that may be included are acyclic carbonates having a C═C unsaturated bond. Examples include methyl vinyl carbonate, ethyl vinyl carbonate, divinyl carbonate, allyl methyl carbonate, allyl ethyl carbonate, diallyl carbonate, aryl phenyl carbonate and diphenyl carbonate.

These other nonaqueous solvents having C═C unsaturated bonds suppress excessive decomposition of the fluorinated carbonates of the invention at the negative electrode, thereby acting to keep the internal resistance of the nonaqueous secondary battery from rising. The molar ratio of the nonaqueous solvent having a C═C unsaturated bond in the nonaqueous solvent as a whole is not more than 5%, and preferably not more than 2%.

Nonaqueous Electrolyte Solution

The nonaqueous electrolyte solution according to an embodiment of the invention is prepared by dissolving an alkali metal salt such as a lithium salt in the nonaqueous solvent obtained by mixing together the fluorinated cyclic carbonate (A) described above and the fluorinated acyclic carbonate (B) described above.

Examples of lithium salts that may be used include LiPF₆, LiBF₄, LiClO₄, LiN(SO₂CF₃)₂, LiN(SO₂C₂F₅)₂, Li[N(SO₂)₂(CF₂)₂] (where, the anion forms a 5-membered ring), Li[N(SO₂)₂(CF₂)₃] (where, the anion forms a 6-membered ring), LiPF₃(CF₃)₃, LiPF₃(C₂F₅)₃, LiBF₃(CF₃), LiBF₃(C₂F₅) and LiB(CO₂CO₂)₂ (where, B(CO₂CO₂)₂ forms two 5-membered rings with B as the shared atom).

In cases where polyfluorinated borate or polyfluorinated phosphate such as LiBF₄, LiBF₃(CF₃) or LiPF₃(C₂F₅)₃ are used, the molar percentage thereof in the lithium salt as a whole is set in a range of preferably up to 40%. When such salts are used, a protective film is formed on the negative electrode, enhancing the thermal stability of the negative electrode.

The concentration of the lithium salt in the nonaqueous electrolyte solution is in a range of preferably from 0.6 to 1.8 mol/L, and more preferably from 1.2 to 1.4 mol/L. By keeping the lithium salt concentration sufficiently high, the oxidation resistance of the nonaqueous solvent increases, enabling to lower the reactivity between the positive electrode in a charged state and the nonaqueous solvent.

Moreover, sodium salts, potassium salts, rubidium salts and cesium salts may be used together with the lithium salt. Anions of these alkali metal salts may be selected from among the anions shown in the above lithium salts. When the another alkali metal salt is used together with the lithium salt, the molar percentage of the lithium salt in the overall alkali metal salt is preferably at least 95%. Similarly to the nonaqueous solvent having a C═C unsaturated bond described above, the presence of a trace amount of the sodium salt or the like acts in such a way as to keep the internal resistance of the nonaqueous secondary battery from rising.

Nonaqueous Secondary Battery

The nonaqueous secondary battery according to an embodiment of the invention may employ a construction similar to that of conventional nonaqueous secondary batteries, provided the nonaqueous electrolyte solution containing the nonaqueous solvent of the present invention is used. The nonaqueous secondary battery of the invention includes, for example, a positive electrode, a negative electrode and a separator.

The positive electrode includes, for example, a positive electrode current collector and a positive electrode active material layer.

A porous or nonporous conductive substrate may be used as the positive electrode current collector. Of these, a porous conductive substrate is preferred from the standpoint of nonaqueous electrolyte solution permeability within an electrode assembly composed of the positive electrode, negative electrode and separator. Examples of porous conductive substrates include mesh materials, net materials, punched sheets, lath materials, porous materials, foams and shaped textiles (e.g., nonwoven fabric). Examples of nonporous conductive substrates include foils, sheets and films. Illustrative examples of the material making up the conductive substrate include metallic materials such as stainless steel, titanium, aluminum and aluminum alloys. The thickness of the conductive substrate, although not subject to any particular limitation, is preferably about 5 to 50 μm.

The positive electrode active material layer includes a positive electrode active material, may optionally include also a conductive agent, a binder or the like, and is preferably formed on one or both sides of the positive electrode active material in the thickness direction thereof.

Examples of positive electrode active materials include lithium transition metal oxides such as lithium cobaltate, lithium nickelate, lithium manganate and lithium iron phosphate; and conductive polymer compounds such as polyacetylene, polypyrrole and polythiophene. Moreover, carbon materials such as activated carbon, carbon black, non-graphitizable carbon, artificial graphite, natural graphite, carbon nanotubes and fullerenes may be used as the positive electrode active material.

These positive electrode active materials do not exhibit the same behavior during charging and discharging. For example, carbon materials and conductive polymer compounds are able, during charging, to take up into the interior thereof anions in the electrolyte solution, and are able, during discharging, to release anions at the interior thereof into the electrolyte solution. On the other hand, lithium transition metal oxides are able, during charging, to release lithium ions present at the interior thereof into the electrolyte solution, and are able, during discharging, to take up into the interior thereof lithium ions present in the electrolyte solution.

The conductive agent used may be one that is commonly employed in this field. Illustrative examples include graphites such as natural graphite and artificial graphite; carbon blacks such as acetylene black, Ketjen black, channel black, furnace black, lamp black and thermal black; conductive fibers such as carbon fibers and metal fibers; metal powders such as aluminum; conductive whiskers such as zinc oxide whiskers and conductive potassium titanate whiskers; conductive metal oxides such as titanium oxide; and organic conductive materials such as phenylene derivatives. The conductive agent may be used singly or as a combination of two or more types.

The binder used may be one that is commonly employed in this field. Illustrative examples include polyvinylidene fluoride, polytetrafluoroethylene, polyethylene, polypropylene, aramid resins, polyamide, polyimide, polyamideimide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinyl pyrrolidone, polyether, polyether sulfone, hexafluoropolypropylene, styrene-butadiene rubber, modified acrylic rubber and carboxymethyl cellulose.

The positive electrode active material layer may be formed by, for example, coating, drying and rolling a positive electrode binder composition slurry on the surface of a positive electrode current collector. The thickness of the positive electrode active material layer is suitably selected according to various conditions, but is preferably about 50 to 100 μm.

The positive electrode composition slurry may be prepared by dissolving or dispersing the positive electrode active material and, if necessary, a conductive agent, binder and the like in an organic solvent. Examples of organic solvents that may be used include dimethylformamide, dimethylacetamide, methylformamide, N-methyl-2-pyrrolidone, dimethylamine, acetone and cyclohexanone.

The negative electrode includes, for example, a negative electrode current collector and a negative electrode active material layer.

A porous or nonporous conductive substrate may be used in the negative electrode current collector. Of these, a porous conductive substrate is preferred from the standpoint of electrolyte solution permeability within the electrode assembly composed of the positive electrode, negative electrode and separator. Examples of porous conductive substrates include mesh materials, net materials, punched sheets, lath materials, porous materials, foams and shaped textiles (e.g., nonwoven fabric). Examples of nonporous conductive substrates include foils, sheets and films. Illustrative examples of the material making up the conductive substrate include metallic materials such as stainless steel, nickel, copper and copper alloys. The thickness of the conductive substrate, although not subject to any particular limitation, is preferably about 5 to 50 μm.

The negative electrode active material layer includes a negative electrode active material, may optionally include also a thickener, a conductive agent, a binder and the like, and is preferably formed on one or both sides of the negative electrode active material in the thickness direction thereof.

Illustrative examples of negative electrode active materials include lithium metal, carbon materials, conductive polymer compounds, lithium-containing transition metal oxides, metal oxides which react with lithium and decompose into lithium oxide and the metal, and alloy-based negative electrode active materials. Alloy-based negative electrode active materials are materials which, at a low negative electrode potential, intercalate lithium at the interior thereof by alloying with lithium, and also reversibly deintercalate lithium.

Illustrative examples of carbon materials includes carbon black, non-graphitizable carbon, artificial and natural graphites coated on the surface with an amorphous carbonaceous substance, carbon nanotubes and fullerenes. Illustrative examples of conductive polymer compounds include polyacetylene and poly-p-phenylene. An example of a lithium-containing metal double oxide is Li₄Ti₅O₁₂. Illustrative examples of metal oxides which react with lithium and decompose into lithium oxide and the metal include CoO, NiO, MnO and Fe₂O₃.

Examples of alloy-based negative electrode active materials include metals that can be alloyed with lithium, and materials which include oxygen and a metal that can be alloyed with lithium. Examples of metals that can be alloyed with lithium include silver, gold, zinc, aluminum, gallium, indium, silicon, germanium, tin, lead and bismuth. Examples of materials which include oxygen and a metal that can be alloyed with lithium include silicon oxides and tin oxides.

Of these negative electrode active materials, a negative electrode active material which intercalates lithium ions during charging and deintercalates lithium ions during discharging is preferred. Specific examples include carbon materials and alloy-based negative electrode active materials. By using such negative electrode active materials, a protective film of lithium fluoride (LiF) forms on the negative electrode surface during initial charging. As a result, the reactivity between the negative electrode and the electrolyte solution in the charged state decreases, enabling a thermally stable state to be created.

Moreover, in the carbon material and the alloy-based negative electrode active material, the alloy-based negative electrode active material is more preferably a material which includes oxygen and an element capable of alloying with lithium, and even more preferably an oxide of silicon or tin. In these oxides, a protective film of lithium oxide (Li₂₀) forms on the surface and, as with the effects of LiF, renders the negative electrode thermally stable.

The negative electrode active material layer may be formed by, for example, coating, drying and rolling a negative electrode binder composition slurry on the surface of a negative electrode current collector. The thickness of the negative electrode active material layer is suitably selected according to various conditions, but is preferably about 50 to 100 μm. The negative electrode composition slurry may be prepared by dissolving or dispersing the negative electrode active material and, if necessary, a conductive agent, binder, thickener and the like in an organic solvent or water. Use may be made of the same conductive agents, binders and organic solvents as those which can be used in preparing the positive electrode composition slurry. The thickener is exemplified by, for example, carboxymethyl cellulose.

In cases where lithium metal is used as the negative electrode active material, a negative electrode active material layer may be formed by bonding a thin sheet of lithium metal to the negative electrode current collector. Alternatively, when an alloy-based negative electrode active material is used as the negative electrode active material, a negative electrode active material layer may be formed by, for example, vacuum deposition, sputtering, chemical vapor deposition or the like.

A separator is provided so as to be interposed between the positive electrode and the negative electrode, and insulates between the positive electrode and the negative electrode. A sheet or film having a given ion permeability, mechanical strength and dielectric properties, etc. may be used as the separator. Specific examples of separators include porous sheets or films such as microporous films, woven fabrics and nonwoven fabrics. Microporous films may be either single-layer films or multilayer films (composite films). If necessary, the separators may be composed of two or more stacked microporous films, woven fabrics and nonwoven fabrics.

The separator is produced from various resin materials. Of the resin materials, taking into account the durability, shutdown function, battery safety and the like, a polyolefin such as polyethylene or polypropylene is preferred. The shutdown function is a function that shuts down the battery reactions when abnormal heat generation arises in the battery. Shutdown is achieved by blocking throughholes and thereby suppressing the passage of ions. The separator thickness is generally from 5 to 300 μm, preferably from 10 to 40 μm, and more preferably from 10 to 20 μm. The separator porosity is preferably from 30 to 70%, and more preferably from 35 to 60%. Here, “porosity” is the total volume of pores present in the separator, expressed as a percentage of the separator volume.

In the nonaqueous secondary battery of the present invention, the electrode assembly produced by interposing a separator between the positive electrode and the negative electrode may have either a stacked or coiled configuration. In addition, the nonaqueous secondary battery of the invention may be produced in various types of shapes. Examples of such shapes include prismatic batteries, cylindrical batteries, coin batteries and metal laminate film-type batteries.

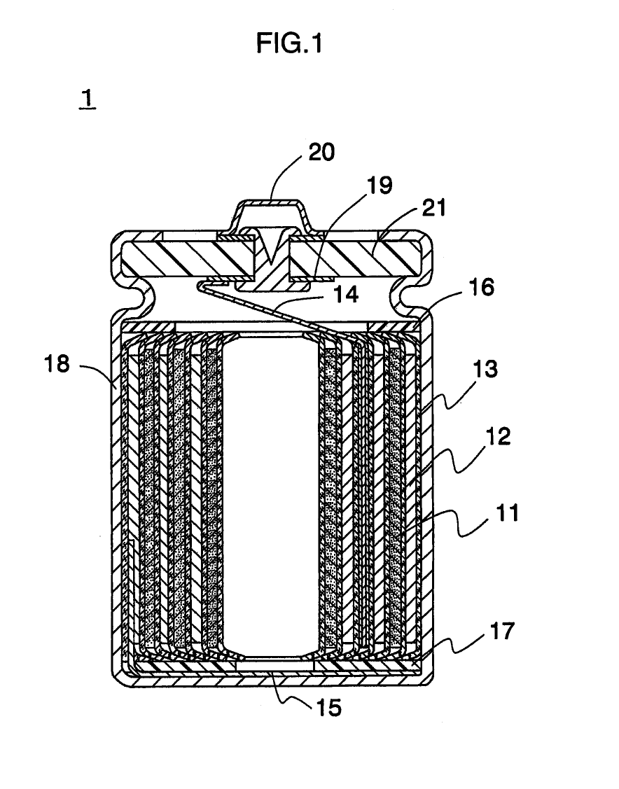

FIG. 1 is a longitudinal sectional view which schematically shows the construction of a cylindrical nonaqueous secondary battery 1 according to one embodiment of the invention. The nonaqueous secondary battery 1 is a cylindrical battery which includes a positive electrode 11, a negative electrode 12, a separator 13, a positive electrode lead 14, a negative electrode lead 15, a top insulating plate 16, a bottom insulating plate 17, a battery case 18, a sealing plate 19, a positive electrode terminal 20, and an electrode solution of the invention which is not shown.

The positive electrode 11 and the negative electrode 12 are coiled spirally with the separator 13 interposed therebetween, thereby producing a coiled electrode assembly. The positive electrode lead 14 is connected at one end to the positive electrode 11, and is connected at the other end to the sealing plate 19. The material making up the positive electrode lead 14 is, for example, aluminum. The negative electrode lead 15 is connected at one end to the negative electrode 12, and is connected at the other end to the bottom of the battery case 18. The material making up the negative electrode lead 15 is, for example, nickel.

The battery case 18 is a closed-bottom cylindrical vessel which is open at one end in the lengthwise direction and is closed at the base on the other end. In this embodiment, the battery case 18 functions as a negative electrode terminal. The top insulating plate 16 and the bottom insulating plate 17 are plastic members which are attached at both ends of the coiled electrode assembly in the lengthwise direction thereof, thereby insulating the coiled electrode assembly from the other members. The electrode case 18 material may be, for example, iron. A plating such as nickel plating may be provided on the inner face of the battery case 18. The sealing plate 19 has a positive electrode terminal 20.

The cylindrical nonaqueous secondary battery 1 may be manufactured, for example, in the following way. First, a positive electrode lead and a negative electrode lead are each connected at one end to predetermined positions on the coiled electrode assembly. Next, the top insulating plate 16 and the bottom insulating plate 17 are attached to the top end and the bottom end, respectively, of the coiled electrode assembly, and the resulting assembly is placed in the battery case 18.

The other end of the positive electrode lead 14 is connected to the sealing plate 19. The other end of the negative electrode lead 15 is connected to the base of the battery case 18. Next, the electrolyte solution of the invention is poured into the battery case 18. The sealing plate 19 is then attached to the opening in the battery case 18, the end of the battery case 18 on the open side thereof is crimped on the inside, thereby fixing in place the sealing plate 19 and sealing the battery case 18. In this way, a nonaqueous secondary battery 1 is obtained. In addition, a plastic gasket 21 is disposed between the battery case 18 and the sealing plate 19.

### EXAMPLES

The invention is described more fully below by way of the following examples and comparative examples.

### Example 1

### Differential Scanning Calorimetry for Various Nonaqueous Solvents in Presence of Charged Positive Electrode

(1) Fabrication of Positive Electrode

A positive electrode composition paste was prepared by mixing together 93 parts by weight of LiCoO₂ powder (available from Nichia Corporation) as the positive electrode active material, 3 parts by weight of acetylene black as the conductive agent, and 4 parts by weight of vinylidene fluoride-hexafluoropropylene copolymer as the binder, and dispersing the resulting mixture in dehydrated N-methyl-2-pyrrolidone. This positive electrode composition paste was coated onto the surface of a 15 μm thick aluminum foil (positive electrode current collector), then dried and rolled to form a positive electrode active material layer having a thickness of 65 μm, thereby producing a positive electrode sheet. The positive electrode sheet was cut to a size of 35 mm×35 mm to give a positive electrode, which was then ultrasonically welded to an aluminum plate having an attached positive electrode lead.

(2) Preparation of Nonaqueous Electrolyte Solution

An electrolyte solution was prepared by using dimethyl carbonate (DMC) as the nonaqueous solvent and dissolving 1 mole of LiPF₆ in 1 liter of this solvent.

(3) Fabrication of Negative Electrode

A negative electrode lead was welded to a 35 mm×35 mm copper plate to form a negative electrode.

(4) Battery Assembly

A polyethylene separator was placed between the positive electrode and the negative electrode, and the aluminum plate and the copper plate were secured together with tape to form an electrode assembly. The electrode assembly was vacuum dried at 85° C. for 1 hour. Next, the electrode assembly was placed in a tubular aluminum laminate pack having both ends open. The positive electrode lead and the negative electrode lead were led out to the exterior through the one opening in the aluminum laminate pack, and this opening was sealed by welding. Next, the electrolyte solution that had been prepared was added dropwise to the aluminum laminate pack interior from the other opening. The interior of the aluminum laminate pack was degassed at 10 mmHg for 5 seconds, following which the other opening was sealed by welding. In this way, a battery was produced.

Using the battery produced as described above, charging (the reaction in which lithium leaves the LiCoO₂ positive electrode active material and deposits on the copper plate at the negative electrode) was carried out at 20° C. and a constant current of 0.7 mA until the battery voltage reached 4.3 V. The battery was then transferred to constant voltage charging at 4.3 V and held at this voltage for 24 hours. The current value after 24 hours was 8 μA.

(5) Modification of Positive Electrode for Differential Scanning Calorimetry

The aluminum foil positive electrode sheet was removed from the battery that had been constant voltage-charged for 24 hours, and washed twice with 70 mL of dimethyl carbonate. The positive electrode sheet was then vacuum dried, removing the dimethyl carbonate. This dried positive electrode sheet was punched in the shape of 3 mm diameter disks, and used as samples of differential scanning calorimeter (DSC).

(6) Nonaqueous Solvent for Differential Scanning Calorimetry

Fluorinated cyclic carbonates represented by formula (I), fluorinated cyclic carbonates represented by formula (II) and fluorinated acyclic carbonates represented by formula (III) were furnished for use as shown in Table 4, Table 5 and Table 6, respectively. These fluorinated carbonates were obtained by the direct fluorination of unsubstituted cyclic carbonates and acyclic carbonates with fluorine gas and purification, as described in, for example, Journal of Fluorine Chemistry 125 (2004), 1205-1209.

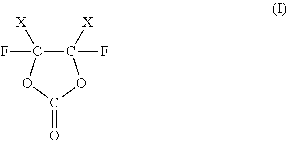

TABLE 4

| Nonaqueous | | |
|---|---|---|
| solvent | X | Y |
| A | H | H |
| B | H | CH₃ |
| C | CH₃ | CH₃ |
| D | H | C₂H₅ |
| E | CH₃ | C₂H₅ |
| F | C₂H₅ | C₂H₅ |

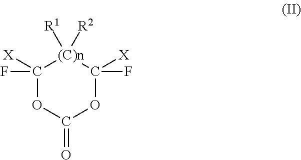

TABLE 5

| Nonaqueous | | | |
|---|---|---|---|
| solvent | X | Y | (CR¹R²)ₙ |
| G | H | H | CH₂ |
| H | H | CH₃ | CH₂ |
| I | CH₃ | CH₃ | CH₂ |

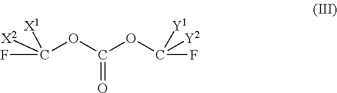

TABLE 6

| Nonaqueous | | | | |
|---|---|---|---|---|
| solvent | X¹ | X² | Y¹ | Y² |
| a | H | H | H | H |
| b | H | H | H | CH₃ |
| c | H | CH₃ | H | CH₃ |
| d | H | H | H | C₂H₅ |
| e | H | CH₃ | H | C₂H₅ |
| f | H | C₂H₅ | H | C₂H₅ |

(7) Differential Scanning Calorimetry

The positive electrode sheet punched out in the form of a 3 mm diameter disk, and 0.7 mg of the respective nonaqueous solvents shown in Tables 4 to 6 that had been weighed out, were placed in a stainless steel sample vessel. The atmosphere within the sample vessel was argon. The samples prepared in this way were heated at a temperature ramp-up rate of 5° C./min, and the heat generation onset temperature at which release of heat from the sample begins was recorded.

The results are shown in Tables 7 and 8.

TABLE 7

| | | | | Heat generation |
|---|---|---|---|---|
| Nonaqueous | | | | onset temperature |
| solvent | X | Y | (CR¹R²)ₙ | (° C.) |
| A | H | H | no | 210 |
| B | H | CH₃ | no | 207 |
| C | CH₃ | CH₃ | no | 206 |
| D | H | C₂H₅ | no | 204 |
| E | CH₃ | C₂H₅ | no | 203 |
| F | C₂H₅ | C₂H₅ | no | 201 |
| G | H | H | CH₂ | 225 |
| H | H | CH₃ | CH₂ | 224 |
| I | CH₃ | CH₃ | CH₂ | 224 |

TABLE 8

| | | | | | Heat generation |
|---|---|---|---|---|---|
| Nonaqueous | | | | | onset temperature |
| solvent | X¹ | X² | Y¹ | Y² | (° C.) |
| a | H | H | H | H | 228 |
| b | H | H | H | CH₃ | 226 |
| c | H | CH₃ | H | CH₃ | 225 |
| d | H | H | H | C₂H₅ | 224 |
| e | H | CH₃ | H | C₂H₅ | 224 |
| f | H | C₂H₅ | H | C₂H₅ | 223 |

From Tables 7 and 8, it is apparent that the heat generation onset temperature in a state where the nonaqueous solvent according to the invention and a positive electrode in a charged state are both present was in each case more than 200° C.

### Comparative Example 1

Cyclic carbonates represented by formula (IX) and acyclic carbonates represented by formula (X) were prepared as shown in Tables 9 and 10, respectively. The thermal reactivities of these carbonates with a positive electrode in a charged state were then evaluated by differential scanning calorimetry in the same way as in Example 1.

The results are shown in Tables 9 and 10.

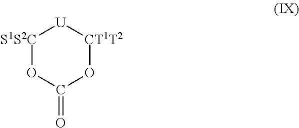

TABLE 9

| | | | | | | Heat generation |
|---|---|---|---|---|---|---|
| Nonaqueous | | | | | | onset temperature |
| solvent | S¹ | S² | T¹ | T² | U | (° C.) |
| J | H | H | H | H | no | 150 |
| K | H | H | H | F | no | 204 |
| L | H | H | F | F | no | 206 |
| M | H | F | F | F | no | 211 |
| N | H | H | H | CH₃ | no | 153 |
| O | H | H | H | CF₃ | no | 162 |
| P | H | H | H | H | CH₂ | 175 |
| Q | H | H | H | H | CF₂ | 177 |

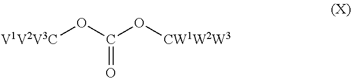

TABLE 10

| | | | | | | | Heat generation |
|---|---|---|---|---|---|---|---|
| Nonaqueous | | | | | | | onset temperature |
| solvent | V¹ | V² | V³ | W¹ | W² | W³ | (° C.) |
| g | H | H | H | H | H | H | 161 |
| h | H | H | H | H | H | F | 162 |
| i | H | H | H | H | F | F | 164 |
| j | H | H | F | H | F | F | 223 |
| k | H | H | H | H | H | CH₃ | 162 |
| l | H | H | H | H | H | CF₃ | 165 |
| m | H | H | CH₃ | H | H | CH₃ | 162 |
| n | H | H | CH₃ | H | H | CF₃ | 164 |
| o | H | H | CF₃ | H | H | CF₃ | 167 |

From Tables 9 and 10, it is apparent that the cases in which the heat generation onset temperature exceeds 200° C. in a state where the nonaqueous solvent of Comparative Example 1 and a positive electrode in a charged state are both present are only those cases where, as in the nonaqueous solvents of the invention, fluorine atoms are bonded to the two alkoxy group carbon atoms adjoining the carbonate oxygen atoms.

### Example 2

### Assembly of Nonaqueous Secondary Battery, Discharge Load Properties of Battery, and Gas Evolution during Storage at 85° C.

(1) Fabrication of Negative Electrode

A negative electrode composition slurry was prepared by mixing together 98 parts by weight of artificial graphite powder (Hitachi Chemical), 1 part by weight of a modified styrene-butadiene-based latex (binder) and 1 part by weight of carboxymethyl cellulose (thickener), then dispersing the resulting mixture in water. This negative electrode composition slurry was coated onto the surface of a 10 μm thick copper foil (negative electrode current collector), then dried and rolled to form on the copper foil surface a negative electrode active material layer having a thickness of 70 μm, thereby giving a negative electrode sheet. This electrode sheet was cut to a size of 35 mm×35 mm and ultrasonically welded to the copper plate having an attached lead, thereby producing a negative electrode.

(2) Preparation of Nonaqueous Electrolyte Solution

Of the nonaqueous solvents shown in Tables 7 to 10, those having heat generation onset temperatures of at least 200° C. were selected and mixed together in combinations like those shown in Table 11 to prepare nonaqueous electrolyte solutions. Here, the mixing ratio of the fluorinated cyclic carbonate to the fluorinated acyclic carbonate, expressed as a molar ratio, was set to 1/1.

TABLE 11

| Nonaqueous | LiPF₆ | | | Discharge | Gas |
|---|---|---|---|---|---|
| electrolyte | concen- | Cyclic | Acyclic | capacity | evolution |
| solution | tration | carbonate | carbonate | (mAh) | (mL) |
| 1 | 0.8M | A | a | 34.9 | 0.085 |
| 2 | 0.8M | B | a | 34.7 | 0.091 |
| 3 | 0.8M | C | a | 34.6 | 0.094 |
| 4 | 0.8M | A | j | 27.2 | 0.098 |
| 5 | 0.8M | B | j | 26.8 | 0.102 |
| 6 | 0.8M | C | j | 26.4 | 0.103 |
| 7 | 0.8M | K | a | 35.3 | 3.3 |
| 8 | 0.8M | L | a | 34.1 | 3.4 |
| 9 | 0.8M | M | a | 32.5 | 3.7 |

(3) Assembly of Nonaqueous Secondary Battery

Using the positive electrode fabricated in Example 1, the negative electrode fabricated in section (1) of this Example 2 and nonaqueous electrolyte solutions Nos. 1 to 9 (Table 11) prepared in section (2) of this Example 2, nonaqueous secondary batteries were assembled in the same way as in Example 1.

(4) Verification of Discharge Capacity of Nonaqueous Secondary Battery

Using these batteries, charging was carried out at 20° C. and a constant current of 0.35 mA, and charging was stopped at a voltage of 4.2 V. Subsequently, discharge was carried out at a constant current of 3.5 mA, and discharging was stopped at a voltage of 3.0 V. The discharge capacities at this time are shown in Table 11.

(5) Measurement of Gas Evolution During Storage at 85° C.

Once again, the battery was charged at a constant current of 0.35 mA to a voltage of 4.2 V, after which the battery was held at this voltage for 24 hours. The battery voltages after such holding were all confirmed to be in a range of 4.188 to 4.189 V, following which these batteries were stored at a temperature of 85° C. for one day. The battery was cooled to room temperature, after which the gas that evolved within the battery was collected and the volume was measured. The results are shown in Table 11.

As shown in Table 11, even though the cyclic carbonate and the acyclic carbonate are both fluorinated, the combination of carbonates which achieved both a high discharge capacity and a low gas evolution are the combinations in nonaqueous electrolyte solutions Nos. 1 to 3. That is, these are only cases in which both the cyclic carbonate and acyclic carbonate had two fluorine atoms on the molecule, with each fluorine atom being bonded to two alkoxy group carbon atoms adjoining carbonate oxygen atoms. When number of fluorine atoms increases, the discharge capacity tends to decrease. Also, when the fluorine atoms are present at asymmetric positions with respect to the carbonate group, the gas evolution at the elevated temperature has a tendency to increase.

It is apparent from Table 11 that 4,5-difluoro-2,3-dioxolan-2-one (difluoroethylene carbonate) is preferred as the fluorinated cyclic carbonate.

### Example 3

### Assembly of Nonaqueous Secondary Battery Using Fluorinated Carbonate, and Discharge Load Properties

(1) Preparation of Nonaqueous Electrolyte Solution

Nonaqueous solvent A in Table 4 was selected as the fluorinated cyclic carbonate, and nonaqueous solvents a to fin Table 6 were selected as the fluorinated acyclic carbonate. The fluorinated cyclic carbonate and the respective fluorinated acyclic carbonates were mixed together in combinations like those shown in Table 12 at a molar ratio of 1/1. Next, 1.2 mole of LiPF₆ was added per liter of each of the mixed solvents, thereby preparing nonaqueous electrolyte solutions.

TABLE 12

| Nonaqueous | | | | Discharge |
|---|---|---|---|---|
| electrolyte | LiPF₆ | Cyclic | Acyclic | capacity |
| solution | concentration | carbonate | carbonate | (mAh) |
| 10 | 1.2M | A | a | 35.7 |
| 11 | 1.2M | A | b | 35.5 |
| 12 | 1.2M | A | c | 35.2 |
| 13 | 1.2M | A | d | 34.7 |
| 14 | 1.2M | A | e | 33.8 |
| 15 | 1.2M | A | f | 32.4 |

(2) Assembly of Nonaqueous Secondary Battery

Using LiCoO₂ as the positive electrode active material and artificial graphite as the negative electrode active material, a battery was assembled in the same way as the nonaqueous secondary battery produced in Example 2.

(3) Verification of Discharge Capacity of Nonaqueous Secondary Battery

Using these batteries, charging was carried out at 20° C. and a constant current of 0.35 mA, and charging was stopped at a voltage of 4.2 V. The battery was subsequently held for 24 hours at a constant voltage of 4.2 V. Next, discharge was carried out at a constant current of 3.5 mA, and discharging was stopped at a voltage of 3.0 V. The discharge capacities at this time are shown in Table 12.

It is apparent from Table 12 that batteries having excellent discharge load properties can be obtained using the nonaqueous electrolyte solutions according to the present invention. The discharge load properties are especially good when nonaqueous solvents a, b and c are used as the fluorinated acyclic carbonate.

### Example 4

### Investigation for Mixing Ratio of Fluorinated Cyclic Carbonate to Fluorinated Acyclic Carbonate

(1) Preparation of Nonaqueous Electrolyte Solution

Nonaqueous solvent C in Table 4 was used as the fluorinated cyclic carbonate. Nonaqueous solvent a in Table 6 was used as the fluorinated acyclic carbonate. In addition, dimethyl carbonate (DMC) was used as an unfluorinated acyclic carbonate. Nonaqueous solvent C, nonaqueous solvent a, and DMC were mixed together in the molar ratios shown in Table 13.

Nonaqueous electrolyte solutions were prepared by dissolving LiPF₆ in a ratio of 1.2 moles per liter of the nonaqueous solvents mixed in these ratios.

TABLE 13

| | Fluor- | Fluor- | | | |
|---|---|---|---|---|---|
| Nonaqueous | inated | inated | | Discharge | Gas |
| electrolyte | cyclic | acyclic | Dimethyl | capacity | evolution |
| solution | carbonate | carbonate | carbonate | (mAh) | (mL) |
| 16 | 1 | 9 | 0 | 35.2 | 0.126 |
| 17 | 2 | 8 | 0 | 35.4 | 0.112 |
| 18 | 3 | 7 | 0 | 35.3 | 0.100 |
| 19 | 4 | 6 | 0 | 35.1 | 0.098 |
| 20 | 5 | 5 | 0 | 34.9 | 0.097 |
| 21 | 6 | 4 | 0 | 34.6 | 0.094 |
| 22 | 7 | 3 | 0 | 34.4 | 0.092 |
| 23 | 8 | 2 | 0 | 34.0 | 0.091 |
| 24 | 9 | 1 | 0 | 33.3 | 0.089 |
| 25 | 4.5 | 4.5 | 1 | 35.1 | 0.099 |
| 26 | 4 | 4 | 2 | 35.3 | 0.102 |
| 27 | 3.5 | 3.5 | 3 | 35.4 | 0.105 |
| 28 | 3 | 3 | 4 | 35.5 | 0.113 |

(2) Assembly of Nonaqueous Secondary Battery

Using LiCoO₂ as the positive electrode active material, artificial graphite as the negative electrode active material, and nonaqueous electrolyte solutions Nos. 16 to 28 prepared in section (1) of this Example 4, nonaqueous secondary batteries were assembled in the same way as the nonaqueous secondary battery produced in Example 2.

(3) Verification of Discharge Capacity of Nonaqueous Secondary Battery

Using these batteries, charging was carried out at 20° C. and a constant current of 0.35 mA, and charging was stopped at a voltage of 4.2 V. Next, discharge was carried out at a constant current of 3.5 mA, and discharging was stopped at a voltage of 3.0 V. The discharge capacities at this time are shown in Table 13.

(4) Measurement of Gas Evolution During Storage at 85° C.

Once again, the battery was charged at a constant current of 0.35 mA to a voltage of 4.2 V, after which the battery was held at this voltage for 24 hours. The battery voltages after holding were all confirmed to be in a range of about 4.2 V, following which these batteries were stored at a temperature of 85° C. for one day. The battery was cooled to room temperature, after which the gas that evolved within the battery was collected and the volume was measured. The results are shown in Table 13.

From Table 13, it is apparent that, in cases where the nonaqueous solvent consists of only the fluorinated cyclic carbonate and the fluorinated acyclic carbonate, good properties are conferred with regard to both the discharge capacity and the gas evolution when the molar ratio of the fluorinated cyclic carbonate to the fluorinated acyclic carbonate is in a range of from 9/1 to 1/9, and especially from 7/3 to 3/7.

Also, it is apparent that, in cases where the nonaqueous solvent includes an unfluorinated carbonate, the proportion thereof is preferably not more than 30 mol % of the overall nonaqueous solvent.

In this Example 4, dimethyl carbonate and its fluorinated carbonate were used as the acyclic carbonate. However, even in cases where ethyl methyl carbonate and its fluorinated carbonate, diethyl carbonate and its fluorinated carbonate, or a mixture thereof are used, substantially similar properties can be obtained so long as the unfluorinated carbonate is present in an amount of not more than 30 mol %.

### Example 5

### Evaluation of Thermal Stability of Nonaqueous Secondary Battery

(1) Preparation of Nonaqueous Electrolyte Solution

Nonaqueous solvent C in Table 4 was used as the fluorinated cyclic carbonate, and nonaqueous solvent b in Table 6 was used as the fluorinated acyclic carbonate. In addition, ethyl methyl carbonate (EMC) was used as an unfluorinated acyclic carbonate. Nonaqueous solvent C, nonaqueous solvent b, and EMC were mixed together in a molar ratio of 4/4/2.

Lithium salts were dissolved, in the proportions shown in Table 14, into per liter of nonaqueous solvent obtained by mixing in such a ratio, thereby giving nonaqueous electrolyte solutions.

TABLE 14

| Nonaqueous | LiPF₆ | | | Heat generation |
|---|---|---|---|---|
| electrolyte | (molar | Other lithium salts | | onset temperature |
| solution | concentration) | (molar concentration) | | (° C.) |
| 29 | 0.8M | LiBF₄ | 0.4M | 155 |
| 30 | 1.0M | | 0.2M | 150 |
| 31 | 1.1M | | 0.1M | 150 |
| 32 | 0.8M | LiBF₃CF₃ | 0.4M | 160 |
| 33 | 1.0M | | 0.2M | 160 |
| 34 | 1.1M | | 0.1M | 155 |
| 35 | 0.8M | LiPF₃(C₂F₅)₃ | 0.4M | 165 |
| 36 | 1.0M | | 0.2M | 160 |
| 37 | 1.1M | | 0.1M | 160 |
| 38 | 1.2M | — | — | 145 |

(2) Assembly of Nonaqueous Secondary Battery

Using LiCoO₂ as the positive electrode active material, artificial graphite as the negative electrode active material, and nonaqueous electrolyte solutions Nos. 29 to 38 prepared in section (1) of this Example 5, nonaqueous secondary batteries were assembled in the same way as the nonaqueous secondary battery produced in Example 2.

(3) Verification of Thermal Stability of Nonaqueous Secondary Battery

Using these batteries, charging was carried out at 20° C. and a constant current of 0.35 mA, and charging was stopped at a voltage of 4.2 V. Charging was subsequently carried out at a constant voltage of 4.2 V, and the battery was held for 24 hours. The battery voltage after 24 hours was about 4.2 V in each case.

Using an accelerating rate calorimeter (ARC), the temperature of these batteries was ramped up in 5° C. steps from room temperature, and the temperature at which the temperature change of the battery became 0.1° C./min was recorded.

The results are shown in Table 14.

It is apparent from Table 14 that the thermal stability of the battery shows greater improvement when LiBF₄, LiBF₃CF₃ and LiPF₃(C₂F₅)₃ as the lithium salts are present together with LiPF₆ than the use of LiPF₆ alone. This is because a protective film is formed on the negative electrode, increasing the thermal stability of the negative electrode.

As explained above, one aspect of the invention is directed to a nonaqueous solvent for a nonaqueous secondary battery, in which the solvent includes (A) at least one fluorinated cyclic carbonate selected from the group consisting of a fluorinated cyclic carbonate represented by the following formula (I)

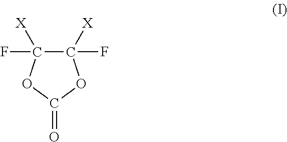

(where, F is fluorine, and X and Y are independently hydrogen or an alkyl group with 1 to 4 carbons) and a fluorinated cyclic carbonate represented by the following formula (II)

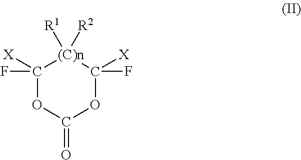

(where F is fluorine, X and Y are independently hydrogen or an alkyl group with 1 to 4 carbons, R¹ and R² are independently hydrogen or an alkyl group with 1 to 4 carbons, and n is an integer from 1 to 3), and (B) a fluorinated acyclic carbonate represented by the following formula (III)

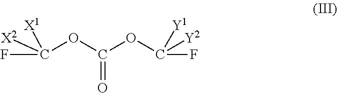

(where, F is fluorine, and X¹, X², Y¹ and Y² are independently hydrogen or an alkyl group with 1 to 4 carbons).

The fluorinated cyclic carbonate (A) of the invention, by substituting with a fluorine atom each of the hydrogens bonded to carbons positioned at two specific positions on the molecule, has an improved thermal stability compared with the unsubstituted cyclic carbonate. At the same time, the fluorinated cyclic carbonate (A) suppresses the reactivity with a positive electrode in a charged state even at elevated temperatures. In addition, the fluorinated cyclic carbonate (A) is able to form, on a negative electrode in the charged state, a protective film which suppresses the reactivity between the negative electrode and the nonaqueous electrolyte solution.

The fluorinated acyclic carbonate (B) of the invention, by having a structure similar to that of the fluorinated cyclic carbonate (A), that is, by being substituted with a fluorine atom at each of the similar carbon positions, suppresses the reactivity with the positive electrode in a charged state and also is able to lower the viscosity of the nonaqueous electrolyte solution.

By employing the nonaqueous electrolyte solution in which the nonaqueous solvent of the invention has been used, the reactivity between the positive electrode and the negative electrode is suppressed even at elevated temperatures, thereby providing the nonaqueous secondary battery of improved safety. Moreover, by forming the protective film on the negative electrode, the secondary battery having low gas evolution during battery storage is provided. In addition, because the electrolyte solution has a low viscosity, the secondary battery with excellent discharge load properties and excellent reliability is provided.

### INDUSTRIAL APPLICABILITY

Because the nonaqueous solvent of the present invention is a mixture of a fluorinated cyclic carbonate having a structure in which one fluorine atom is bonded to each of two carbons at specific positions on the molecule and a fluorinated acyclic carbonate having a similar structure, it has excellent thermodynamic, kinetic and chemical reaction stability. By using this nonaqueous solvent, it is possible to enhance at the same time not only the safety of the nonaqueous secondary battery, but also its reliability, such as the discharge load characteristics and the storage properties at elevated temperatures.

The nonaqueous secondary battery of the invention can be used in the same applications as conventional nonaqueous secondary batteries, and is particularly useful as a power supply for handheld electronic devices, such as PCs, cell phones, mobile devices, portable digital assistants (PDAs), video cameras and handheld gaming consoles. The inventive battery also shows promise for use as secondary batteries which assist the driving of electric motors in hybrid electric vehicles, electric vehicles and fuel cell vehicles, as power supplies for driving robots and the like, and as power sources for plug-in hybrid electric vehicles (HEVs).

1. A nonaqueous solvent for a nonaqueous secondary battery, containing
(A) at least one fluorinated cyclic carbonate selected from the group consisting of a fluorinated cyclic carbonate represented by the following formula (I) 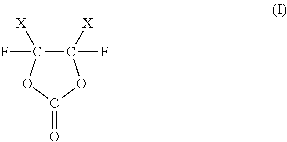
(where, F is fluorine, and X and Y are independently hydrogen or an alkyl group with 1 to 4 carbons) and a fluorinated cyclic carbonate represented by the following formula (II) 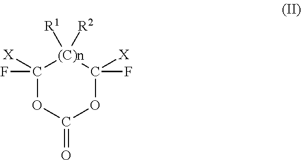
(where, F is fluorine, X and Y are independently hydrogen or an alkyl group with 1 to 4 carbons, R¹ and R² are independently hydrogen or an alkyl group with 1 to 4 carbons, and n is an integer from 1 to 3), and
(B) a fluorinated acyclic carbonate represented by the following formula (III) 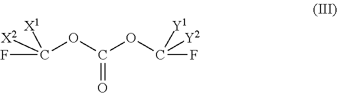
(where, F is fluorine, and X¹, X², Y¹ and Y² are independently hydrogen or an alkyl group with 1 to 4 carbons).

2. The nonaqueous solvent according to claim 1, wherein the fluorinated cyclic carbonate (A) is the fluorinated cyclic carbonate represented by formula (I).

3. The nonaqueous solvent according to claim 2, wherein the fluorinated cyclic carbonate (A) is the fluorinated cyclic carbonate represented by the following formula (IV)

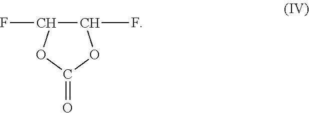

4. The nonaqueous solvent according to claim 1, wherein the fluorinated cyclic carbonate (A) is the fluorinated cyclic carbonate represented by formula (II).

5. The nonaqueous solvent according to claim 1, wherein the letter n in the fluorinated cyclic carbonate represented by formula (II) is 1.

6. The nonaqueous solvent according to claim 1, wherein the fluorinated acyclic carbonate (B) is at least one selected from the group consisting of the fluorinated acyclic carbonate represented by the following formula (V), 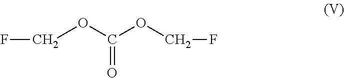
the fluorinated acyclic carbonate represented by the following formula (VI),
and 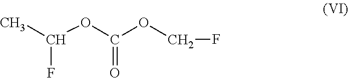
the fluorinated acyclic carbonate represented by the following formula (VII).

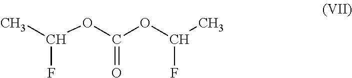

7. The nonaqueous solvent according to claim 1, wherein the molar ratio, (A)/(B), of the fluorinated cyclic carbonate (A) to the fluorinated acyclic carbonate (B) is from 3/7 to 7/3.

8. The nonaqueous solvent according to claim 1, wherein the total content, (A)+(B), of the fluorinated cyclic carbonate (A) and the fluorinated acyclic carbonate (B) is from 70 to 100 mol % in the nonaqueous solvent.

9. A nonaqueous electrolyte solution prepared by dissolving an ionic-dissociating alkali metal salt as an electrolyte into the nonaqueous solvent according to claim 1.

10. A nonaqueous secondary battery comprising a positive electrode and a negative electrode capable of a reversible electrochemical reaction with the alkali metal ions, and the nonaqueous electrolyte solution according to claim 9.
